(19) United States
(12) Patent Application Publication
(10) Pub. No.: US 2026/0127262 A1
(43) Pub. Date: May 7, 2026

(54) System and Method for Allowlisting of Devices

(71) Applicant: PC Matic Inc, Sioux City, IA (US)

(72) Inventors: Zachary A. Austin, Beverly Hills, FL (US); Robert J. Cheng, Myrtle Beach, SC (US); Andrew Tuch, Boca Raton, FL (US); Robert J. Woodworth, Charleston, SC (US); Matthew Quincy Riley, Owosso, MI (US)

(73) Assignee: PC Matic Inc, SIOUX CITY, IA (US)

(21) Appl. No.: 18/934,350

(22) Filed: Nov. 1, 2024

(51) Int. Cl. G06F 21/44; G06F 8/41; G06F 21/60; G06F 21/62

(52) U.S. Cl. CPC G06F 21/44; G06F 8/41; G06F 21/604; G06F 21/62; G06F 2221/2141

(57) ABSTRACT

During development, a whitelist is automatically created that includes entries for all programs that will run on the target device. Security software is included in the installation package. After the installation package is installed, the operating system runs the system security software and the system security software intercepts attempts to run any program and only allows programs to run that match an entry in the whitelist. In some embodiments, an entitlement file is created (manually, automatically, or a combination of both) and is included in the installation package. In such embodiments, after initialization, the system security software intercepts attempts to access resources of the target device by programs and only allows access to resources that are identified in the entitlement file for that program.

### FIELD OF THE INVENTION

This invention relates to the field of computer security and more particularly to a system for generation of whitelist entries during the system build process.

### BACKGROUND OF THE INVENTION

The proliferation of low to medium functionality devices (often referred to as the Internet of Things (IoT)) has brought about a transformative wave of interconnected devices designed to enhance convenience, efficiency, and automation across various sectors. Many homes have many connected devices (e.g., connected by Wi-Fi or other wireless mechanisms) such as appliances, light controls, electronic door locks, ceiling fans, stereo systems, televisions, wireless cameras, light bulbs, network interfaces, Wi-Fi repeaters, Wi-Fi routers, etc. Each device has an interface to the internet through this wireless mechanism and many such devices include a processor, memory, and an operating system of some sort. In many small devices, the operating system is some form of LINUX®.

Although these connected devices typically have single-purpose functions, these connected devices have become a new frontier for bad actors and global hackers seeking to exploit vulnerabilities for malicious purposes.

Such connected devices typically operate on specialized, lightweight operating systems optimized for their constrained resources and specific tasks. These operating systems facilitate seamless interaction with other devices and networks, enabling the connected device ecosystem's growth. However, the prevalence of such operating systems also introduces a potential avenue for attackers to gain unauthorized access, execute arbitrary code, or inject malware. This can be achieved through various mechanisms, including weak authentication mechanisms, code vulnerabilities, and insufficient security protocols.

Compounding the issue is the inherent single-purpose nature of many IoT devices. While this characteristic enhances their efficiency and usability, it also limits their ability to defend against sophisticated attacks. Hackers capitalize on this limitation by exploiting the device's primary function to introduce malicious code that can propagate across the network, compromise data integrity, or even render the device inoperable. Take a wireless camera; one would not want an intruder to be able to access images from a wireless camera that the owner believes is secure.

The consequences of these attacks range from minimal to severe. Although an irritation, if a hacker is able to turn on one of your lights, it isn't the end of the world, and therefore, a minimal threat. Unfortunately, once threat actors (e.g., hackers) compromise a connected device, the threat actor is able to launch distributed denial of service (DDoS) attacks that are capable of overwhelming servers and networks with traffic while disrupting critical online services. Additionally, the injection of malware into connected devices can lead to widespread data breaches of other devices on the network, the theft of sensitive information from other devices on the network, and unauthorized access to connected systems.

Beyond the potential for immediate disruptions caused by attacks, connected devices often control critical infrastructure, such as industrial systems, medical equipment, and transportation networks. Exploiting vulnerabilities in these connected devices can result in physical harm, financial losses, and the compromise of personal safety. For example, should a certain brand of electronic entry lock be compromised and the hacker causing every electronic entry lock of that brand to open at a certain time, people who depend on those locks will be vulnerable to others entering their residences, theft, and bodily harm.

Therefore, what is needed is a mechanism for protecting such connected devices from attacks.

### SUMMARY OF THE INVENTION

In one embodiment, a system for device security is disclosed including a target device that has a processor, and a memory operatively interfaced to the processor. Security software is stored in the memory and runs on the processor. A whitelist that contains entries indicating which programs are allowed to run on the processor is stored in the memory and accessible by the security software. When a program attempts to be executed by the processor, the security software intercepts and determines when the program is authorized using the whitelist. When the program is unauthorized, the security software prevents execution of the program and when the program is authorized, the security software allows the execution of the program. When each program is made (e.g., compiled/linked) by a build system (e.g., a computer system for building a firmware image for installation on the target device) from source code and libraries (e.g., built, compiled, linked), a whitelist entry is automatically generated and added to the whitelist after the program is created.

In another embodiment, a system for device security is disclosed. The system includes a target device that has a processor and a memory that is interfaced to the processor and a build system (e.g., a computer system for building a firmware image for installation on the target device). Using the program-build system, control program source code is compiled/linked to create a control program, security software source code is compiled/linked to create a security software program, and operating system source code are compiled/linked to create operating system programs for running on the target device. The program-build system automatically generates a whitelist entry in a whitelist for the control program and each program in the operating system. The program-build system generates a firmware image that comprises the control program, the whitelist, the security software program, and the operating system programs. Upon installation of the firmware image on the target device, the control program, the security software program, the operating system programs, and the whitelist are stored in the memory and the whitelist is thereby accessible by the security software program. Upon initialization, the operating system runs on the processor and the operating system starts the security software program. Thereafter, when any program attempts to be executed by the operating system, the security software intercepts this execution and determines if the program is authorized using the whitelist and when the program is unauthorized, the security software prevents execution of the program, and when the program is authorized, the security software allows the execution of the program.

In another embodiment, a method of protecting a target device is disclosed including, in a program-build environment, compiling and linking a control program, compiling and linking a security software program, compiling and linking operating system programs. The control program, the security software program, and the operating system programs are created to run on a target device. The program-build environment automatically generates a whitelist entry for the control program and each of the operating system programs and adds the whitelist entry to a whitelist. A firmware image is created that includes the control program, the security software program, the operating system programs, and the whitelist. The firmware image is installed on the target device, including installing of the control program, the security software program, the operating system programs, and the whitelist in a memory of a target device, the target device having a processor and the memory is operatively interfaced to the processor. The security software has access to the whitelist, the whitelist containing entries indicative of which programs are allowed to run on the processor. Upon initialization of the target device, the operating system runs on the processor and the operating system runs the security software program. When any program attempts to execute by the operating system, the security software program intercepts and determines when the program is authorized using the whitelist, and when the program is unauthorized, the security software program preventing execution of the program. When the program is authorized, the security software program allows the execution of the program.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a software build environment of the prior art.

FIG. 2 illustrates a schematic view of a software build environment with automatic whitelist generation.

FIG. 3 illustrates a schematic view of a software build environment with automatic whitelist generation and entitlement restrictions.

FIG. 4 illustrates a sample list of entitlements.

FIG. 5 illustrates a typical computer as used by the present invention.

FIGS. 6 and 7 illustrate exemplary program flows of a software build environment with automatic whitelist generation.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

To understand the disclosed protection mechanisms, a short description of how one develops software that operates hardware such as a wireless interface (e.g., Wi-Fi) and other hardware follows. Note that this disclosure is in no way limiting to the disclosed protection mechanism.

As an example, development of a simple wireless lightbulb includes a hardware design (e.g., power conversion circuit, LEDs, LED drivers, and Wi-Fi interface). Once the hardware design is complete, a software developer typically writes software to control the LED drivers based upon signals received from the Wi-Fi interface. The drivers for various hardware and the operating system are added to firmware written by a developer to perform the desired tasks. A software development kit often has menus of hundreds of modules for performing various functions and controlling various hardware.

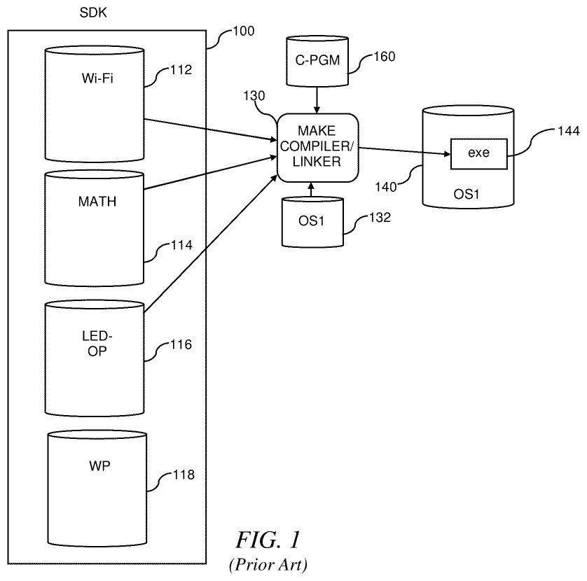

Referring to FIG. 1, a software build environment of the prior art is shown. In this, the software developer is creating a system for controlling the light bulb (as above). To gain access to previously written software libraries, the software developer obtains (e.g., purchases) a software developer kit 100 (e.g., SDK). Often, a software developer kit 100 will contain many libraries of already written and debugged software modules, but the software developer kit 100 shown has only four modules for brevity reasons: a Wi-Fi module 112, a math module 114, an LED control operations module 116, and a word processor module 118. The software developer selects which modules from the software developer kit 100 to include in the application, in this example, only Wi-Fi module 112, the math module 114, and the LED control operations module 116 are included as there is no need for a word processor module 118 in a light bulb as there is no keyboard and display.

The software developer creates a control program that ties operations together between the selected modules 112/114/116 and the hardware of the light bulb, for example, initiating connections through the Wi-Fi module 112, receiving commands and sending status through the Wi-Fi module 112, generating color selections and soft on/off algorithms using the math module 114, and controlling the LED control hardware using the LED control operations module 116. Once developed, the control program 160 and the selected modules 112/114/116 are compiled and linked using a compiler/linker 130 for the target operating system 132 (e.g., the target platform) to create an executable program 144 that is included in a binary 140 or installation program. The target operating system 132 (e.g., Embedded LINUX® operating system) is also included in the binary 140 or installation package.

When the software developer uses a library having a vulnerability, the vulnerability is open to others (e.g., hackers) to capitalize and cause problems. For example, if the library for the wireless interface has a vulnerability that allows installation of unwanted programs, a hacker has the ability to install a rouge program on every lightbulb having the final code. This might not seem like a big issue, but as the lightbulb is interfaced to the Internet through the Wi-Fi adapter, the hacker could instruct thousands of lightbulbs to make connections to a website that hosts an important function, for example, a financial institution. That website would be so busy processing connections from these thousands of lightbulbs that the website would not be able to allow connections to those needing access, denying legitimate users from accessing their accounts, etc.

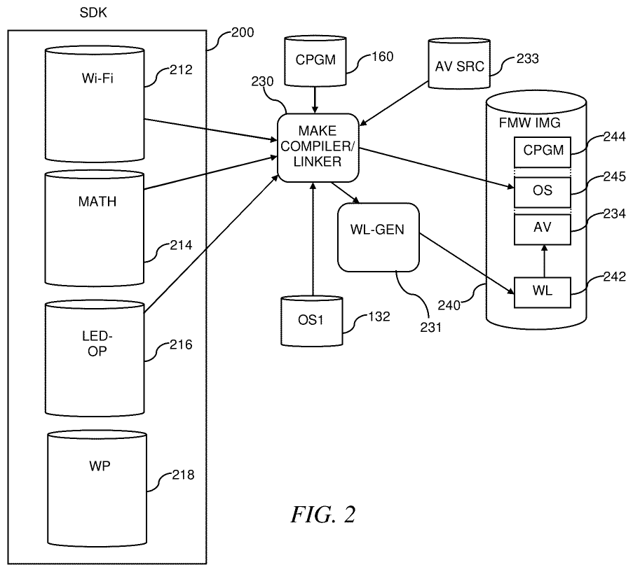

Referring to FIG. 2, a software build environment of the present invention is shown. In this, the software developer is again creating a system for controlling the light bulb (as above). To gain access to previously written software libraries, the software developer obtains (e.g., purchases) a software developer kit 200 (e.g., SDK). Often, a software developer kit 200 will contain many libraries of already written and debugged software modules, though the software developer kit 200 shown has only four modules for brevity reasons: a Wi-Fi module 212, a math module 214, an LED control operations module 216, and a word processor module 218. The software developer selects which modules from the software developer kit 200 to include in the application, in this example, only Wi-Fi module 212, the math module 214, and the LED control operations module 216 are included as there is no need for a word processor module 218 in a light bulb as there is no keyboard and display.

As above, the software developer creates a control program 160 that ties operations together between the selected modules 212/214/216 and the hardware of the light bulb, for example, initiating connections through the Wi-Fi module 212, receiving commands and sending status through the Wi-Fi module 212, generating color selections and soft on/off algorithms using the math module 214, and controlling the LED control hardware using the LED control operations module 216. Once developed, the control program 160, the security software source code 233, and the selected modules 212/214/216 are compiled and/or linked using a compiler/linker 230 for the target operating system 132 to create a firmware image 240 that includes the security software program 234, the control program 244, and all operating system programs 245 and files in a. The firmware image includes target operating system 132 files (e.g., embedded LINUX® operating system) as well. The compiler/linker 230 also feeds a whitelist generator 231 that creates (or adds to) a whitelist 242 entries for the executable(s) 244/245 that are created by the compiler/linker 230. The whitelist generator 231 also generates whitelist entries for executables of the target operating system 132 for inclusion in the whitelist 242 so that the various programs needed by the target operating system 132 are allowed to run (e.g., are on the whitelist 242).

An antivirus module or security software source code 233 (guard program) is compiled and linked into a control program 244 that is included in the firmware image 240. Once the firmware image 240 is installed and running, the security software program 234 runs and intercepts attempts to run programs and prevents execution of any program that does not match an entry in the whitelist 242 (e.g. any unauthorized program). Therefore, should there be a vulnerability in one of the modules 212/214/216 or the control program 160 that allows downloading and installation of a rouge program, the rouge program will be prevented from running as it is not present in the whitelist. Further, if such vulnerability allows malware to modify an existing program, the check value stored in the whitelist 242 is used to recognize the modification and the program will no longer match the whitelist 242 and that program will not be allowed to run as well.

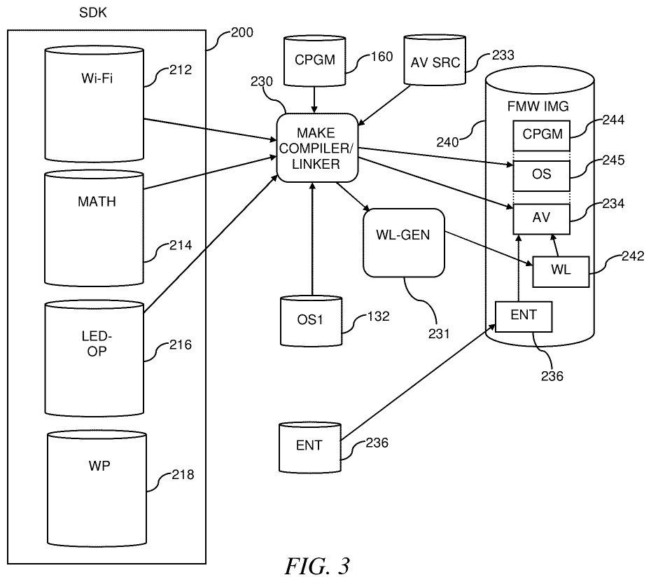

Referring to FIG. 3, a software build environment of the present invention is shown with entitlement checking. In this, the software developer is creating a system for controlling the light bulb (as above). To gain access to previously written software libraries, the software developer obtains (e.g., purchases) a software developer kit 200 (e.g., SDK). Often, a software developer kit 200 will contain many libraries of already written and debugged software modules, but the software developer kit 200 shown has only four modules for brevity reasons: a Wi-Fi module 212, a math module 214, an LED control operations module 216, and a word processor module 218. The software developer selects which modules from the software developer kit 200 to include in the application, in this example, only Wi-Fi module 212, the math module 214, and the LED control operations module 216 are included as there is no need for a word processor module 218 in a light bulb as there is no keyboard and display.

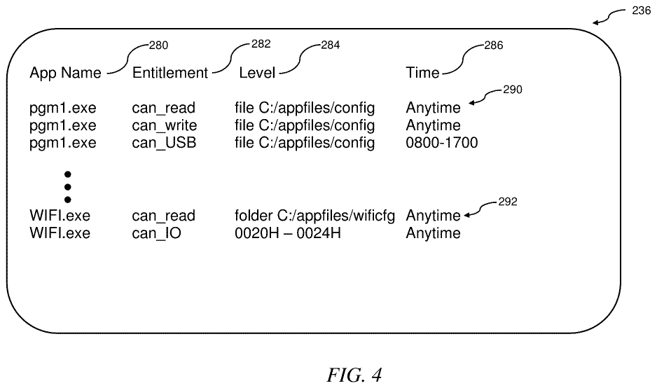

In this embodiment, an entitlement file 236 is provided by the developer and/or created during the “make” process. The entitlement file 236 (see example in FIG. 4) includes allowances or restrictions to operating system features that are available to each running program in the target system. Examples of entitlements are “can read,” “can write,” “can modify,” “can manage,” “can install,” “can ssh” (super shell), “can use USB,” etc. In some embodiments, the entitlements are also time based (e.g., “can modify between 9:00 AM and 5:00 PM”).

Prior to building the firmware image 240, the developer assigns the available entitlements to each program (in this example, the control program 244 is shown for clarity reasons) using the entitlement file 236, optionally at a specific level. Example of levels include file level, folder level, user level, group level, etc. For example, the control program 244 can only open one file, the config file, and cannot spawn other programs. Another example is the Wi-Fi program cannot spawn other programs which would prevent a rouge program from being started by a flaw in the Wi-Fi program. The entitlements are stored in the entitlement file 236 (see FIG. 4) that is included in the firmware image 240. When a resource is accessed by a program in the target device, the security software intercepts the access and checks the entitlement file 236 to determine if the action is allowed or not.

In some embodiments, some or all of the entitlements are automatically generated by analyzing the program. For example, if the program opens a file with a fixed filename (e.g., “c:/usr/config”), then after analysis of the program, an entitlement to opening this file is automatically added to the entitlement file. If instead, the program opens a variable filename (e.g., “fopen(myfilename, “rw”)), then the location or path to this file is unknown and the developer must manually specify that the program is entitled to open files anywhere, open files in a certain path, only able to open certain files, etc.

As above, the software developer creates a control program 160 that ties operations together between the selected modules 212/214/216 and the hardware of the light bulb, for example, initiating connections through the Wi-Fi module 212, receiving commands and sending status through the Wi-Fi module 212, generating color selections and soft on/off algorithms using the math module 214, and controlling the LED control hardware using the LED control operations module 216. Once developed, the control program 160, libraries (e.g., modules 212/214/216), the security software source code 233, and target operating system 132 are compiled and/or linked using a compiler/linker 230 for the target operating system 132, thereby creating executable programs 234/244/245 that are included in the firmware image 240. Outputs of compiler/linker 230 are fed to a whitelist generator 231 that creates whitelist 242 with entries for the executable(s) programs 234/244/245 that are created by the compiler/linker 230. As the whitelist generator 231 also generates whitelist entries from the target operating system 132 for inclusion in the whitelist 242, the various programs needed by the target operating system 132 are allowed to run (e.g., are on the whitelist 242). Note that the whitelist generator 231 creates whitelist entries for each output of the compiler/linker 230, including the control program 244 and any library executable (e.g., a DLL) and operating system executable, etc.

The antivirus module or security software source code 233 (guard program) is made (e.g., compiled and linked) for the target device 10 and an executable version, the security software program 234 is included in the firmware image 240. Once installed and running, the security software program 234 intercepts attempts to run programs and prevents execution of any program that is not in the whitelist 242. Therefore, should a vulnerability in one of the modules 212/214/216 allow downloading and installation of a rouge program, the rouge program will be prevented from running as it is not present in the whitelist. Further, if such vulnerability allows malware to modify an existing program, the check value stored in the whitelist 242 is used to recognize the modification and the program will no longer match the whitelist 242 or certificate and that program will not be allowed to run as well.

In summary, during the development and manufacture process of a firmware image 240 for a target device 10 (e.g., build process), a whitelist 242 is automatically created that includes whitelist entries for all programs that will run on the target device 10. Further, the security software source code 233 is provided and manufactured during the build process to produce the security software program 234 that is also included in the firmware image 240 along with operating system programs 245 designed for the target device 10. In some embodiments, an entitlement file 236 is created (automatically, manually, or a combination of both) and included in the firmware image 240. The firmware image 240 is installed on the target device 10 and, upon initialization, the operating system programs 245 runs on a processor of the target device 10, loading the security software program 234. Thereafter, the security software program 234 intercepts attempts to run any program and checks each program against the whitelist 242, only allowing programs to run that match an entry in the whitelist 242 (e.g., have a valid check value such as a CRC, signature, checksum...). In some embodiments, an entitlement file 236 is created (manually, automatically, or a combination of both) and is included in the firmware image 240. In such embodiments, after initialization, the system security software program 234 intercepts attempts to access resources of the target device 10 by programs and only allows access to resources that are identified in the entitlement file 236 for that program. Note that it is fully anticipated that the security program 234 performs other tasks such as virus detection.

Referring to FIG. 4, an exemplary entitlement file 236 is shown. In this, there are one or more entries for each program or application 280 and each entry includes an entitlement 282, the level 284 to which the entitlement is given, and optionally the time frame 286 in which the entitlement is authorized. In the example of FIG. 4, the first line 290 includes an entitlement for pgm1.exe that this program is able to read a specific file at any time. In another line 292, WIFI. exe can read an entire folder at any time. Note that some entitlements are fixed to a single resource (e.g., able to get the time-of-day or able to force a reboot) while some entitlements require parameters (e.g., able to read files in a specific folder, able to read/write ports 3A-3C, able to read memory locations 1000-13FF).

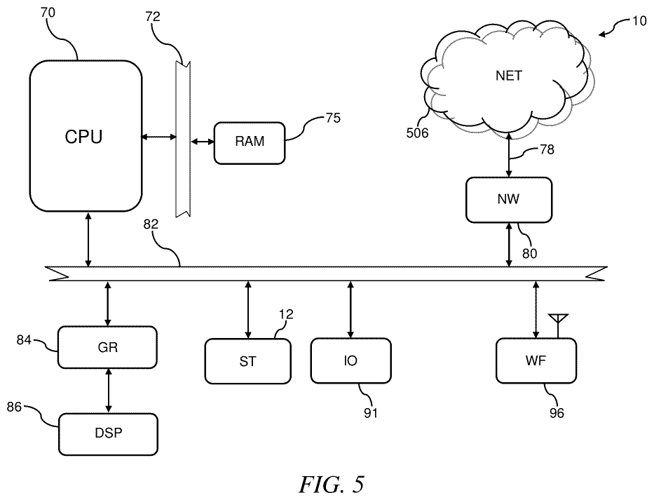

Referring to FIG. 5, a schematic view of a typical target device 10 is shown representing a target device (e.g., the lightbulb) or a server on which the build environment is provided. The present invention is in no way limited to any particular device 10. Protection for many processor-based devices is equally anticipated including, but not limited to smart phones, cellular phones, portable digital assistants, routers, thermostats, fitness devices, smart watches etc.

The exemplary device 10 is shown in its simplest form. Different architectures are known that accomplish similar results in a similar fashion, and the present invention is not limited in any way to any particular computer system architecture or implementation. In this typical device 10, a processor 70 executes or runs programs in a random-access memory 75. The programs are generally stored within a persistent memory, storage 12, and loaded into random-access memory 75 when needed. The processor 70 is any processor suitable for the device 10. The random-access memory 75 is interfaced to the processor by, for example, a memory bus 72. The random-access memory 75 is any memory suitable for connection and operation with the selected processor 70, such as SRAM, DRAM, SDRAM, RDRAM, DDR, DDR-2, etc. The storage 12 is any type, configuration, capacity of memory suitable for persistently storing data, for example, flash memory, read only memory, battery-backed memory, hard disk, etc. In some exemplary target computers 10, the storage 12 is removable, in the form of a memory card of appropriate format such as SD (secure digital) cards, micro-SD cards, compact flash, etc.

Also connected to the processor 70 is a system bus 82 for connecting to peripheral subsystems such as a network interface 80 (wired or wireless), a graphics adapter 84 and user I/O devices 91 such as LEDs, mice, keyboards, touchscreens, etc. The graphics adapter 84 receives commands from the processor 70 and controls what is depicted on the display 86. The user I/O devices 91 provides navigation and selection features.

In general, some portion of the storage 12 is used to store programs, executable code, and data, the whitelist 242, etc. In some embodiments, other data is stored in the storage 12 such as audio files, video files, text messages, etc.

The peripherals shown are examples, and other devices are known in the industry such as Global Positioning Subsystems, speakers, microphones, USB interfaces, cameras, microphones, Bluetooth transceivers, Wi-Fi transceivers 96, image sensors, temperature sensors, etc., the details of which are not shown for brevity and clarity reasons.

In some embodiments, a network interface 80 connects the typical device 10 to the network 506 through any known or future protocol such as Ethernet, Wi-Fi, GSM, TDMA, LTE, etc., through a wired or wireless medium 78. There is no limitation on the type of connection used. In such, the network interface 80 provides data and messaging connections between the typical device 10 and a server computer through the network 506 for various purposes, including downloading of the binary 140 or installation program.

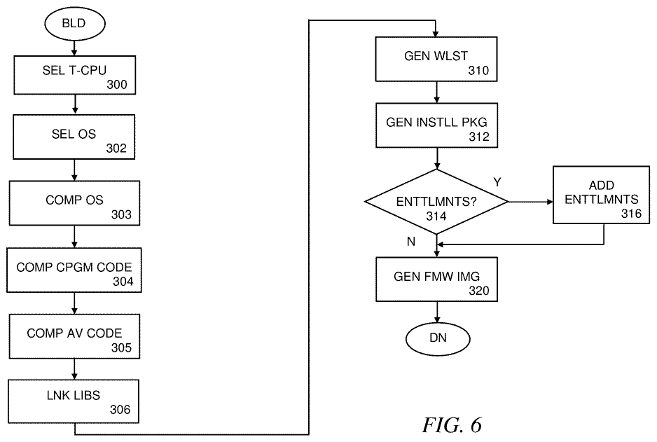

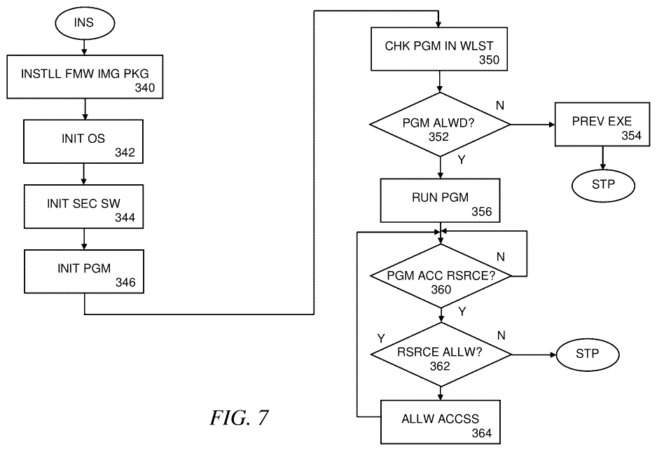

Referring to FIGS. 6 and 7, exemplary program flows of a software build environment with automatic whitelist generation are shown.

In FIG. 6, the build environment is described using an exemplary program flow starting with selecting 300 a target CPU (e.g., embedded processor). Next an operating system is selected 302 (e.g., a version of embedded Linux for the target CPU). Next, the build environment compiles 303 the target operating system 132, compiles 304 the control program 160 (source code), compiles 305 the security software source code 233, and links 306 the compiled source code with the libraries. The build environment then generates 310 a whitelist 242 from outputs of the compilation. Next, the build environment generates 312 the firmware image 240 to include the programs compiled, including the control program 244 the security software program 234, the operating system, and the whitelist 242. If 314 there are entitlements in the entitlement file 236 which are optional, the entitlements from the entitlement file 236 are added 316 and included in the firmware image 240. Now the firmware image 240 is generated 320 and is ready to be installed on the target device 10.

In FIG. 7, installation and running of the firmware image 240 is shown in an exemplary program flow. The firmware image 240 is installed 340 and the operating system is initiated 342. Once the operating system is initiated 342, the security software program 234 is initiated 344. Once the security software program 234 is running and protecting the device, the program(s) is initiated 346. The security software program 234 checks 350 the program against the whitelist 242 and determines if the program (executable control program 244) is authorized by checking the program against the whitelist 242 by name, size, checksum, CRC, signature, etc. If the program is not authorized 352, the program is prevented from running 354 (e.g., stopped). If the program is authorized 352, the program runs 356 on the processor of the target device. In embodiments with entitlement restrictions, when the program attempts to access a resource 360, if 362 the program is not allowed to access that resource, the program is stopped (depending upon configuration details) and, in some embodiments, a logfile entry is created. Otherwise, if 362 the program is allowed to access that resource, access to the resource is allowed 364 and the program continues.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for device security, the system comprising:
a target device, the target device having a processor and a memory operatively interfaced to the processor, the memory is non-transitory;
security software stored in the memory; the security software running on the processor;
a whitelist stored in the memory and accessible by the security software, the whitelist containing entries indicative of which programs are allowed to run on the processor;
when a program attempts to be executed by the processor, the security software intercepts execution and determines when the program is authorized using the whitelist and when the program is unauthorized, the security software prevents execution of the program;
when the program is authorized, the security software allows the execution of the program; and
whereas, when each program is created from source code by a compiler/linker running on a computer in a build environment, a whitelist entry is automatically generated and added to the whitelist after the program is created.

2. The system of claim 1, further comprising an entitlement list for the program, the entitlement list stored in the memory, when the program attempts to access a resource of the processor, the security software intercepts and determines when the program is entitled to access the resource using the entitlement list and when access to the resource is prevented, the security software prevents the access of the resource by the program, otherwise when the access to the resource is allowed based upon the entitlement list, the security software allows the access of the resource by the program.

3. The system of claim 2, wherein the entitlement list comprises one or more entitlements selected from a group consisting of reading a file, writing the file, reading an input/output device, writing to the input/output device, reading a memory location, and writing a memory location.

4. The system of claim 2, wherein the entitlement list further comprises a range of times that the program is entitled to access the resource and when the security software intercepts and determines when the program is entitled to access the resource using the entitlement list, the access to the resource is allowed only during the range of times.

5. A system for device security, the system comprising:
a target device, the target device having a processor and a memory operatively interfaced to the processor, the memory is non-transitory;
a program-build system in which control program source code is compiled/linked to create a control program, security software source code is compiled/linked to create a security software program, and operating system source code are compiled/linked to create operating system programs to run on the target device, the program-build system automatically generates a whitelist entry in a whitelist for the control program and each program in the operating system programs; the program-build system generates a firmware image that comprises the control program, the whitelist, the security software program, and the operating system programs;
upon installation of the firmware image on the target device, the control program, the security software program, the whitelist, and the operating system programs are stored in the memory, the whitelist is thereby accessible by the security software program;
upon initialization, the operating system programs run on the processor and the operating system programs start the security software program;
thereafter, when a program attempts to be executed by the operating system programs, the security software program intercepts execution of the program and determines when the program is authorized using the whitelist and when the program is unauthorized, the security software program prevents execution of the program; and
when the program is authorized, the security software program allows the execution of the program.

6. The system of claim 5, further comprising an entitlement list for each program, the entitlement list as added to the firmware image and, upon installation, the entitlement list is read from the firmware image and installed in the memory such that when the program attempts to access a resource of the processor, the security software program intercepts and determines when the program is entitled to access the resource using the entitlement list and when access to the resource is prevented, the security software program prevents access of the resource by the program, otherwise when the access to the resource is allowed based upon the entitlement list, the security software program allows the access of the resource by the program.

7. The system of claim 6, wherein the entitlement list comprises one or more entitlements selected from a group consisting of reading a file, writing the file, reading an input/output device and writing to the input/output device.

8. The system of claim 6, wherein an entry in the entitlement list further comprises a range of times that the program is entitled to access the resource and when the security software program intercepts and determines when the program is entitled to access the resource using the entitlement list, the access to the resource is allowed only during the range of times.

9. A method of protecting a target computer, the method comprising:
in a program-build environment, compiling and linking a control program from source code, compiling and linking a security software program, compiling and linking operating system programs, the control program, the security software program, and the operating system programs are created to run on a target device, the program-build environment automatically generating a whitelist entry for the control program and each of the operating system programs and adding the whitelist entry to a whitelist;
creating a firmware image that comprises the control program, the security software program, the operating system programs, and the whitelist for the target device;
installing the firmware image, including installing of the control program, the security software program, the operating system programs, and the whitelist in a memory of a target device, the target device having a processor and the memory is operatively interfaced to the processor, the memory being non-transitory, the security software program having access to the whitelist, the whitelist containing entries indicative of which programs are allowed to run on the processor;
upon initialization of the target device, the operating system programs running on the processor and the operating system programs run the security software program;
when attempting to execute a program by the operating system programs, the security software program intercepting and determining when the program is authorized using the whitelist, and when the program is unauthorized, the security software program preventing execution of the program; and
when the program is authorized, the security software program allowing the execution of the program.

10. The method of claim 9, further comprising an entitlement list for the program, the entitlement list included in the firmware image and, during installing the firmware image, storing the entitlement list in the memory; thereafter, when attempting to access a resource by the program, the security software program intercepting and determining when accessing of the resource by the program is allowed by using the entitlement list and when accessing of the resource by the program is not allowed, the security software program preventing access of the resource by the program, otherwise when accessing of the resource by the program is allowed based upon the entitlement list, the security software program allowing the access of the resource by the program.

11. The method of claim 10, wherein the entitlement list comprises one or more entitlements selected from a group consisting of accessing a file system, accessing the file system for reading, accessing the file system for reading and writing, reading a file, writing the file, reading an input/output device and writing to the input/output device.

12. The method of claim 11, wherein the one or more entitlements of accessing the file system are limited to a portion of the file system.

13. The method of claim 12, wherein the entitlement list further comprises a range of times for the whitelist entry and when interceding and determining when the program is entitled to access the resource using the entitlement list, the security software program allowing the access to the resource only during the range of times.
